(19) United States
(12) Patent Application Publication
(10) Pub. No.: US 2005/0182497 A1
(43) Pub. Date: Aug. 18, 2005

(54) Manufacturing system, gateway device, and computer product

(75) Inventor: Nobumasa Nakano, Aichi (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 11/059,653

(22) Filed: Feb. 17, 2005

(30) Foreign Application Priority Data
Feb. 18, 2004 (JP) 2004-041972
Jul. 27, 2004 (JP) 2004-219342

(51) Int. Cl. G05B 19/18

(52) U.S. Cl. 700/2; 700/149

(57) ABSTRACT

The gateway device that connects a control device and a controlled device includes a receiving unit that receives a control request written in an abstract interface description language from the control device; a converter that converts the control request to driver control information; a driver that converts the driver control information to controlled-device control information and controls the controlled device based on the controlled-device control information; and a transmitting unit that transmits the controlled-device control information to the controlled device.

### BACKGROUND OF THE INVENTION

1) Field of the Invention

The present invention relates to a manufacturing system including a gateway device that connects a control device to a plurality of controlled devices, and converts a command from the control device to a command that can be interpreted and executed by any one of the controlled devices.

2) Description of the Related Art

Conventionally, flexible manufacturing systems in which facilities as targets for control are connected to a control device through a network have been proposed and are becoming increasingly common. The facilities include various types of machine tools, setup devices, cleaning devices, operation instructing devices, and conveying devices, and so on. These devices serve as production facilities and actually perform machining, cleaning, and transporting of works. The control device integrally controls the operations of these facilities while processing some pieces of basic information such as a machining schedule plan, machining sequence information, and information for jig to be used, which are used to operate the facilities, and preparing operating schedules.

An example of the flexible manufacturing systems is the one in which the control device is divided into devices for each functional element of the facilities, and the devices control the operations of the facilities. The example is also the one in which an information flow as the whole system is made smooth and highly efficient by discretely providing communication lines. One of the communication lines is provided for transmission of control information used to control the operations of the facilities, and another communication line is provided for transmission of operation information used to manage the operation of the flexible manufacturing system (see, for example, Japanese Patent Application Laid-Open No. H1-234143).

However, the flexible manufacturing system described in Japanese Patent Application Laid-Open No. H1-234143 and the like are often constructed by combining the facilities and the control device that are manufactured in different vendors. In such cases, the meanings of parameters that are set in the facilities and the data formats and interface models that are used in the facilities and the control device are different from one another for each vendor.

A common interface model for controllers as a de-fact standard includes EZSocket, Manufacturing Operation Information Interface (MOII), and Open Robot Interface for the Network (ORIN). These are not a model unified as a device, but are based on a general function as a controller that forms the device. Therefore, it is necessary to convert, by application, the general function to specific information for a case which component of the device is to be controlled.

There is a variety of interface models as the de-fact standard other than the above-mentioned common interface models. When such interface models are to be used, it is necessary to design applications each of which allows an access to be made. In other words, the control device requires an application for each facilities (each specifications of facilities as a target for control) that are controlled by the control device, and there is no versatility in a combination of a control device and facilities. Furthermore, the works for developing the applications are needed, and the work is carried out for each facilities. Thus, a large burden is put on developers of the applications.

### SUMMARY OF THE INVENTION

It is an object of the present invention to solve at least the problems in the conventional technology.

A manufacturing system according to an aspect of the present invention includes a gateway device that connects a control device and a controlled device. The gateway device includes a receiving unit that receives a control request written in an abstract interface description language from the control device; a converter that converts the control request to driver control information; a driver that converts the driver control information to controlled-device control information and controls the controlled device based on the controlled-device control information; and a transmitting unit that transmits the controlled-device control information to the controlled device.

A gateway device according to another aspect of the present invention connects a control device and a controlled device, and includes a receiving unit that receives a control request written in an abstract interface description language from the control device; a converter that converts the control request to driver control information; a driver that converts the driver control information to controlled-device control information and controls the controlled device based on the controlled-device control information; and a transmitting unit that transmits the controlled-device control information to the controlled device.

A computer-readable recording medium according to still another aspect of the present invention stores a computer program that causes a computer, which functions as a gateway device between a control device and a controlled device, to execute receiving a control request written in an abstract interface description language from the control device; converting the control request to driver control information; converting the driver control information to controlled-device control information for controlling the controlled device; and transmitting the controlled-device control information to the controlled device.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a diagram for explaining the overview of a conventional manufacturing system;

FIG. 2 is a diagram for explaining the overview of a manufacturing system according to the present invention;

FIG. 3 is a diagram for explaining the overview of the manufacturing system according to the present invention;

FIG. 4 is a diagram for explaining a relationship between a driver and a controller;

FIG. 5 is a diagram for explaining a relationship between two drivers and two controllers;

FIG. 6 is a diagram for explaining a relationship between three drivers and three controllers;

FIG. 7 is a flowchart of a procedure of the whole operation of the manufacturing system according to the present invention;

FIG. 8 is a diagram for explaining a control path;

FIG. 9 is a diagram for explaining another control path;

FIG. 10 is a diagram for explaining still another control path;

FIG. 11 is a diagram of an example of description in abstract interface description language;

FIG. 12 is a diagram of an example of description in IDL;

FIG. 13 is a flowchart of a procedure of the operation of a control device in the manufacturing system;

FIG. 14 is a flowchart of the operation of a gateway device in the manufacturing system;

FIG. 15 is another flowchart of the operation of the gateway device in the manufacturing system;

FIG. 16 is still another flowchart of the operation of the gateway device in the manufacturing system;

FIG. 17 is a flowchart of the operation of a controlled device in the manufacturing system;

FIG. 18 is a diagram of a correspondence information list between control request information and driver control information;

FIG. 19 is a diagram of a control request information list;

FIG. 20 is a diagram of driver control information (process information) lists;

FIG. 21 is a diagram of a correspondence information list between the driver control information (process information) and controlled-device control information;

FIG. 22 is a diagram of a driver control information (process information) list;

FIG. 23 is a diagram of a controlled-device control information list; and

FIG. 24 is a diagram of another configuration of the controlled device.

### DETAILED DESCRIPTION

Exemplary embodiments of a manufacturing system, a gateway device, and a recording medium according to the present invention are explained in detail below with reference to the accompanying drawings. It is noted that the present invention is not limited by the explanation below and modifications can be allowed as required unless they depart from the scope of the present invention.

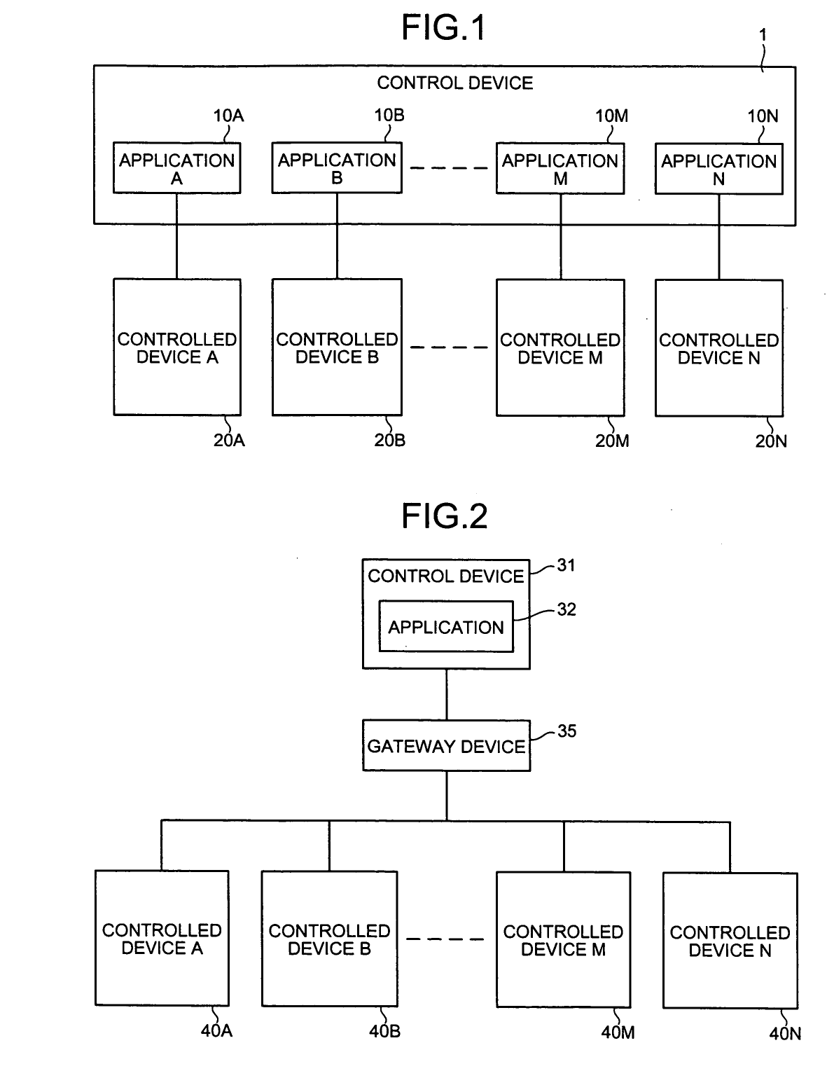

The overview of the present invention is explained below based on comparison with the conventional one. The flexible manufacturing systems in which facilities as targets for control are connected to a control device through a network have been proposed. The facilities include various types of machine tools that serve as production facilities and actually perform machining, cleaning, and conveying of works, respectively. The control device integrally controls the operations of these facilities while processing pieces of basic information such as a machining schedule plan and machining sequence information used for operations of these facilities, and preparing operating schedules. However, in the conventional flexible manufacturing system, as shown in FIG. 1, an application for controlling the control device and a controlled device controlled by the application have a one-to-one correspondence, and therefore, each controlled device needs to have a specific application for each specification thereof.

Referring to FIG. 1, for example, an application A10A specific to control of a controlled device A20A is prepared for the controlled device A20A, and an application B10B specific to control of a controlled device B20B is prepared for the controlled device B20B. Furthermore, an application M10M specific to control of a controlled device M20M is prepared for the controlled device M20M, and an application N10N specific to control of a controlled device N20N is prepared for the controlled device N20N. In other words, if N pieces of the controlled device are present, N pieces of applications specific to the control of the controlled devices are required. This is because the meanings of parameters set in the controlled devices are different from each other for each vendor, and the data formats and the interface models used in the controlled devices and the control devices are also different from each other for each vendor.

In this case, if the controlled device A20A is to be replaced with a controlled device AA (not shown) as a new product, the controlled device AA cannot be controlled by the application A10A. In other words, the application A10A also has to be replaced with an application AA (not shown). In the event of trouble with the application A10A, for example, the controlled device A20A cannot be controlled by any other application such as the application B10B. Therefore, it is impossible to operate the controlled device A20A until the application A10A is replaced with another application A10A or the application A10A is fixed. That is, in the conventional system, a combination of the application and the controlled device is restricted. Likewise, if a plurality of controllers of different specifications is present in one controlled device, an application is required for each controller.

On the other hand, as shown in FIG. 2, the present invention allows one application 32 (or a plurality of applications) provided in a control device 31, through a gateway device 35, to control a plurality of controlled devices A40A to N40N. With this configuration, the existing application 32 can control the controlled device AA (not shown) even if the controlled device A40A is replaced with the controlled device AA. Furthermore, when a new controlled device P (not shown) is introduced, the existing application 32 can also control the controlled device P.

That is, the present invention allows a highly flexible manufacturing system to be achieved by providing flexibility to the combination of the application and the controlled device. Although only one application is described in FIG. 2, the application according to the present invention is not limited to one, and a plurality of applications can also be used.

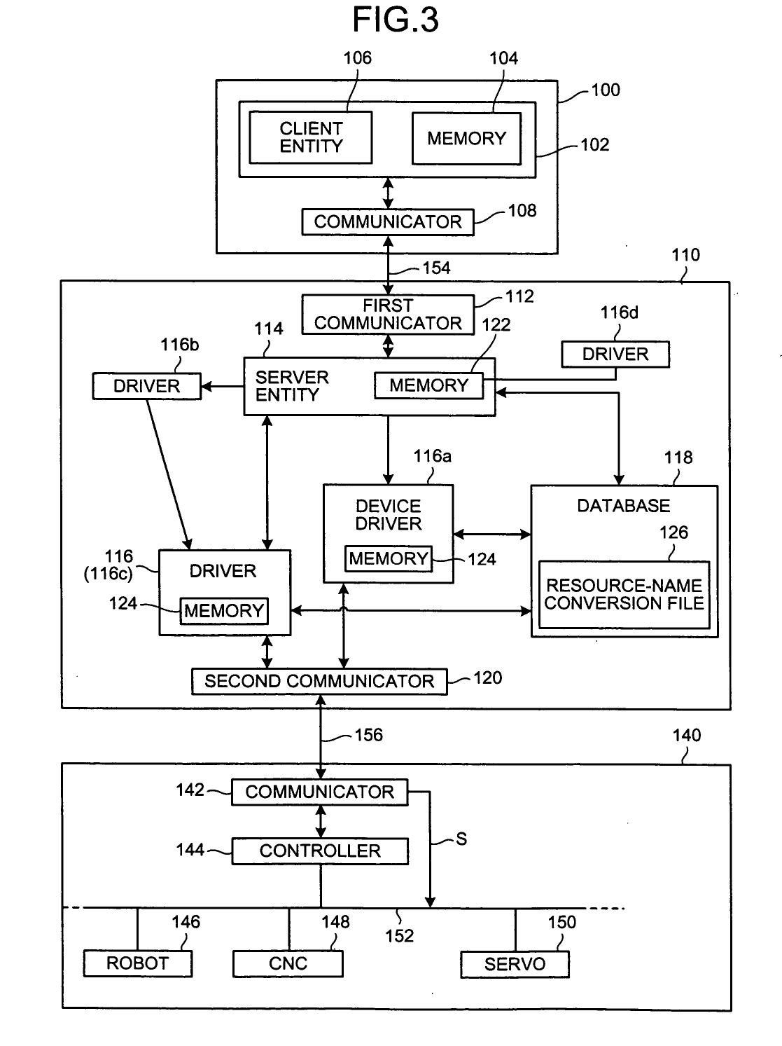

FIG. 3 is a schematic diagram of an example of a manufacturing system according to an embodiment of the present invention. The manufacturing system according to the present invention includes a control device 100, a gateway device 110, and a controlled device 140 that are connected by communication lines 154 and 156, respectively.

The control device 100 controls the controlled device 140, and, for example, a general-purpose computer can be used for the control device 100. The control device 100 includes an application 102 and a communicator 108. The application 102 includes a memory 104 and a client entity 106. The memory 104 serves as a storage unit and stores control request information describing control requests for the controlled device 140 in abstract specification. The client entity 106 executes the process for a control request for the gateway device 110. The communicator 108 is a communication unit that communicates with the gateway device 110.

The application 102 transmits control request information to the gateway device 110 in order to control the controlled device 140 based on a predetermined instruction of a user. The user can control of the controlled device 140 by selecting a desired control from the control request information in the application 102. FIG. 3 describes only one application for easy understanding, but in the present invention, not only a single application but also a plurality of applications are possible to be present in the control device 100.

Herein, the control request information describing the control requests for the controlled device 140 in the abstract specification is a set of interfaces that is accessible (possible to request) from the control device 100, i.e., executable by the controlled device 140.

The control request information also includes driver selection information of the gateway device 110 as appended information. A plurality of drivers can be present in the gateway device 110 as explained later. The driver selection information is used for selection of a driver by a converter in the gateway device 110, as explained later, when the drivers are present therein.

An interface accessible from the control device 100 can be obtained from installation specifications, a mechanical design package, a control software (S/W) design package, a control panel design package, or controller specifications for the controlled device 140 and components thereof. The control device 100 has pieces of control request information, i.e., interfaces for the controlled devices 140, which allows control of the controlled devices 140 with one application.

The interfaces can include a set of whole interfaces in capability description of the controlled device 140 or element devices (components) that form the controlled device 140, the interfaces being offered outside. The interfaces can also include an interface specific to the gateway device 110 (capabilities specific to a gateway device) provided by the gateway device 110 that is explained later. The capabilities mentioned here are such that functions of the controlled device 140 and of components forming the controlled device 140 are defined in an interface description language.

As such capabilities, functions as follows executed by the controlled device 140 and the components are described. That is, the functions include various functions such as access management, job management, operation management, carrying-in/carrying-out management, performance management, diagnosis, date & hour management, event management, work management, tool management, recipient/machining execution, alarm management, object management, recipient/machining data management. The capabilities are described in the abstract specification. In other words, in the capability description, description on specifications specific to vendors is excluded, and only functions of devices and components thereof are defined. The definitions are described in the abstract interface description language, for example, Interface Definition Language (IDL).

The communicator 108 is a communication unit that communicates with the gateway device 110, and exchanges various information data therewith. When the control device 100 is to control the controlled device 140, the control request information is transmitted to the gateway device 110 through the communicator 108. When various pieces of information are returned from the controlled device 140 and the gateway device 110, the communicator 108 receives these pieces of information.

The gateway device 110 is connected between the control device 100 and the controlled device 140 so as to enable communications with both of them, and accommodates differences in environments between the control device 100 and the controlled device 140. This configuration allows information exchange between the control device 100 and the controlled device 140 that are constructed in different specifications. Specifically, information data conversion is performed between the control device 100 and the controlled device 140. With this configuration, the gateway device 110 converts the information sent from the control device 100 to data information that can be interpreted and operated by the controlled device 140, and inputs the data information to the controlled device 140. Furthermore, the gateway device 110 converts the data information sent from the controlled device 140 to data information that can be interpreted by the control device 100, and inputs the data information to the control device 100. Based on the configuration, even if the control device 100 and the controlled device 140 are constructed not in the same specifications, the gateway device 110 can accommodate the differences in the specifications. This allows information exchange between the control device 100 and the controlled device 140 and allows highly versatile control for the controlled device 140.

The gateway device 110 includes a first communicator 112, a server entity 114, a driver 116, a database 118, and a second communicator 120.

The first communicator 112 is a communication unit that communicates with the control device 100, and exchanges various information data therewith. When the control device 100 is to control the controlled device 140, the first communicator 112 receives the control request information transmitted from the control device 100. When various pieces of information are to be returned from the controlled device 140 and the gateway device 110 to the control device 100, the first communicator 112 transmits these pieces of information thereto.

The server entity 114 constructs client-server architecture with the client entity 106, and functions in response to a control request from the client entity 106. The server entity 114 is a converter that converts the control request information, which is sent from the control device 100 (client entity 106) and is received by the first communicator 112, to driver control information used to operate the driver 116. The conversion of the control request information to the driver control information is performed based on a correspondence information list between the control request information and the driver control information that is stored in a memory 122 of the server entity 114. The driver control information is not yet a format corresponding to the specifications of the controlled device but is information in an abstract description format. As explained later, the driver 116 can be present in plurality. If a plurality of the drivers 116 is present, the server entity 114 also selects any one of the drivers based on the driver selection information included in the control request information. The correspondence information list between the control request information and the driver control information can also be changed to a format in which the correspondence information list is stored in the database 118. The correspondence information list also includes reverse-conversion correspondence information used to convert return value information to data information that can be interpreted by the control device 100. The return value information is obtained by converting, in the driver 116, a return value from the controlled device 140 as explained later to data information that can be interpreted by the server entity 114. The reverse-conversion correspondence information can be stored discretely as a reverse-conversion correspondence information list. The return value mentioned here includes various pieces of information transmitted from a low-order device, such as abnormal value information, error value information, and operation confirmation information.

The driver 116 converts driver control information to controlled-device control information (device correspondence command corresponding to each of the controlled devices 140). The driver control information is converted in the server entity 114 that is the converter, and is used to operate the driver 116. The controlled-device control information, to be transmitted to the controlled device 140, corresponds to the specifications of the controlled device and the components thereof. The controlled-device control information also corresponds to communication environment to be connected. The driver 116 converts the driver control information to the controlled-device control information (device correspondence command) based on a correspondence information list that is stored in a memory 124 of the driver 116. The correspondence information list describes correspondence between the driver control information and the controlled-device control information (device correspondence command). It is noted that the correspondence information list is also possibly changed to a format in which it is stored in the database 118. The correspondence information list also includes reverse-conversion correspondence information used to convert a return value to data information that can be interpreted by the server entity 114 as a higher-order device. The return value is returned from the controlled device 140 to the gateway device 110 as data information that can be interpreted by the controlled device 140. It is noted that the reverse-conversion correspondence information may be stored discretely as a reverse-conversion correspondence information list. The return value mentioned here includes various pieces of information transmitted from a low-order device, such as abnormal value information, error value information, and operation confirmation information.

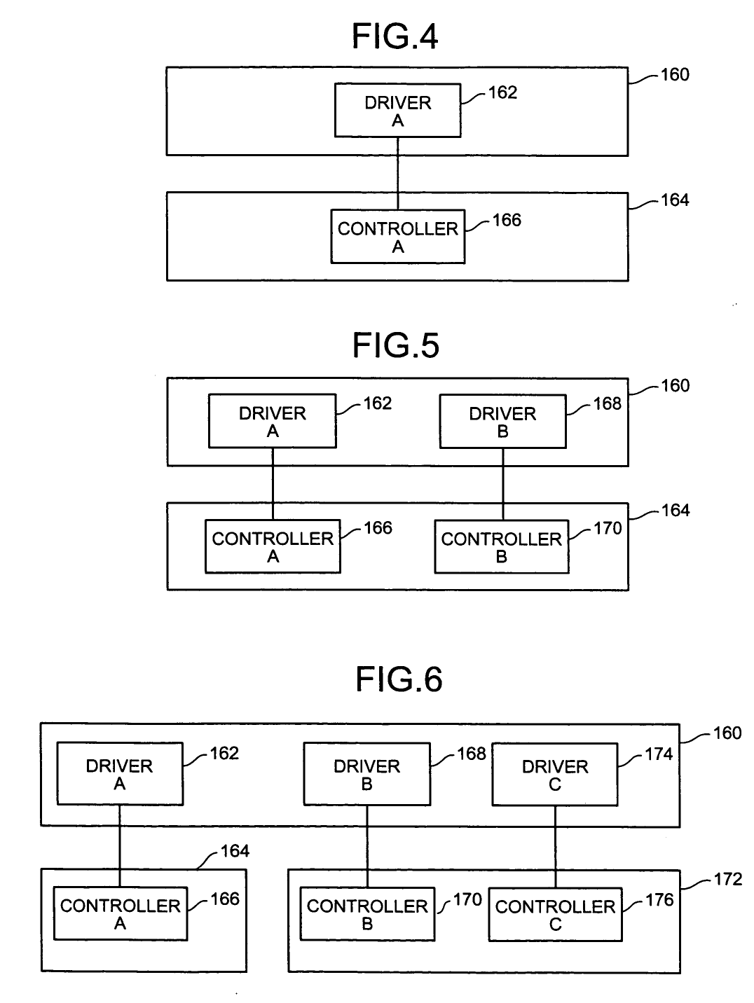

The driver 116 has a one-to-one correspondence with a controller 144 that is provided in the controlled device 140 and controls the controlled device 140 and the components thereof. The driver 116 is prepared by the same number as that of the controller 144 of the controlled device 140. For example, as shown in FIG. 4, if one controlled device 164 is provided and includes one controller A 166, a gateway device 160 requires one driver A 162 corresponding to the controller A 166. As shown in FIG. 5, if one controlled device 164 is provided and includes two units of the controller A 166 and a controller B 170, the gateway device 160 requires two units of the driver A 162 and a driver B 168 corresponding to the controller A 166 and the controller B 170, respectively. As shown in FIG. 6, if two units of the controlled device 164 and a controlled device 172 are provided, and if the controlled device 164 includes the controller A 166 and the controlled device 172 includes the controller B 170 and a controller C 176, the gateway device 160 requires three units of the driver A 162, the driver B 168, and a driver C 174 corresponding to the controller A 166, the controller B 170, and the controller C 176, respectively. As shown in FIG. 4 to FIG. 6, the components other than the drivers and controllers are omitted in the gateway device and the controlled device.

The database 118 is a storage unit that stores various data files. For example, if the database 118 stores a correspondence information list file that describes correspondence between the control request information and the driver control information, the server entity converts the control request information to the driver control information based on the data file stored in the database 118. If the database 118 stores a correspondence information list file that describes correspondence between the driver control information and the controlled-device control information (device correspondence command), the driver 116 converts the driver control information to the controlled-device control information (device correspondence command) based on the data file stored in the database 118.

The database 118 stores a resource-name conversion file 126. The resource-name conversion file 126 is a correspondence information list that describes correspondence between a mounting address with particular bits and an attribute-value name (logical name) with particular bits that corresponds to the mounting address. The mounting address is provided in each interface of the controlled device 140 and the components thereof in capability description format. In the controlled device 140 and the components thereof, particular bits in a particular hardware register (word register, byte register) are often designated. The designation is performed with the mounting address in the conventional technology. However, the mounting address becomes a long description, which causes a mistake in designation to easily occur, and the specifications of the mounting address or the like are difficult to understand.

In the capability description in the abstract interface language (e.g., IDL) of the present invention, the particular bits of the controlled device 140 and the components thereof are described in logical names. The gateway device 110 has the resource-name conversion file 126 in the database 118, which allows the logical name to be converted to the mounting address with particular bits based on the resource-name conversion file 126. The conversion is performed when the driver 116 refers to the resource-name conversion file 126 in the database 118. With this conversion, the resources of the controlled device 140 and the components thereof are described and identified with the logical name under higher-order environment than the driver 116, and the information is transmitted. In lower-order environment than the driver 116, i.e., in the controlled device 140 and the components thereof, the resources are designated with the mounting addresses in the same manner as the conventional technology, and the information is transmitted.

According to this, it is possible to easily identify the specifications of the particular bits of the controlled device 140 and the components thereof when viewed from the application side, and to prevent the mistake in the designation.

An example of correspondence description is explained below. The correspondence description is included in the resource-name conversion file 126 and indicates correspondence between a logical name of an arbitrary resource and a mounting address.

<Resource Logical Name-Mounting Address Correspondence Description (One Example)>
“Xxx: abc1001. xyz2000. reg5. bit7”

In the resource logical name-mounting address correspondence description, the logical name “Xxx” indicates correspondence to the mounting address with the resource of “abc1001”, the controller of “xyz2000”, the register of “No. 5”, and “the seventh bit of 16 bits”.

The second communicator 120 is a communication unit that communicates with the controlled device 140, and exchanges various information data therewith. When the controlled device 140 is to be controlled, the second communicator 120 transmits the controlled-device control information (command) converted in the driver 116 to the controlled device 140. When various pieces of information are to be returned from the controlled device 140 and the components thereof, the second communicator 120 receives these pieces of information. Although the first communicator 112 and the second communicator 120 are separately explained here, the functions of the first communicator 112 and the second communicator 120 can be executed by one communicator.

Each connection between the control device 100 and the gateway device 110 and between the gateway device 110 and the controlled device 140 may be provided through a network or through a discrete communication line. The connection type is not particularly limited, and any one of communication types can be provided.

The controlled device 140 includes a communicator 142, the controller 144, and components (devices) that form the controlled device 140, such as a robot 146, a computer numerical controller (CNC) 148, and a servo 150.

The communicator 142 is a communication unit that communicates with the gateway device 110, and exchanges various information data therewith. When the control device 100 is to control the controlled device 140, the communicator 142 receives the controlled-device control information (device correspondence command) transmitted from the gateway device 110. When various pieces of information are to be returned from the controlled device 140 and the components (devices) thereof, the communicator 142 transmits these pieces of information to the gateway device 110.

The controller 144 is a control unit that controls the controlled device 140 according to the controlled-device control information, and controls the controlled device 140 and the components thereof based on the controlled-device control information (device correspondence command) transmitted from the driver 116 of the gateway device 110 and received by the communicator 142. Although only one controller is described in FIG. 3, a plurality of controllers can be provided so as to share the controls for the components in the controlled device. The controller 144 has a one-to-one correspondence with the driver 116 of the gateway device 110 for each specification of the controllers 144. Therefore, if a plurality of controllers is present, a driver corresponding to the specifications of each controller is provided in the gateway device 110. If various pieces of information are to be returned from the controlled device 140 and the components (devices) thereof, the pieces of information are transmitted to the gateway device 110 through the controller 144.

As the components, the robot 146, the CNC 148, and the servo 150 are described in FIG. 3, but in the present invention, the components of the controlled device 140 are not limited thereto. Therefore, various types of components and further more units of components can be controlled. The components and the controller may be connected through a network or through a discrete communication line. The connection type is not particularly limited, and any one of communication types can be provided.

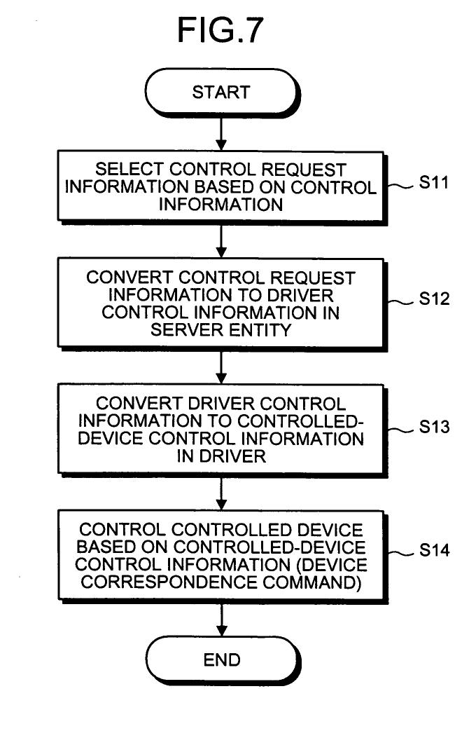

How to control the controlled device 140 in the manufacturing system configured in the above manner is explained below with reference to FIG. 7. In the control device 100, the user selects a request item (control request information) for the controlled device that is accessible from the control device, and enters the control request information (step S11) to be transmitted to the gateway device 110 through the application 102. The control request information is transmitted the gateway device 110 from the client entity 106 through the communicator 108.

In the gateway device 110, the first communicator 112 receives the control request information transmitted from the control device 100. The server entity 114 converts the control request information to driver control information used to operate the driver 116, and transmits the driver control information to the driver 116 (step S12). The conversion is performed based on the correspondence information list between the control request information and the driver control information that is stored in the memory 122 of the server entity 114. If the driver 116 is present in plurality, the server entity 114 also selects a driver based on the driver selection information included in the control request information.

The driver 116 converts the driver control information transmitted from the server entity 114 to controlled-device control information (device correspondence command) that corresponds to the specifications of the controlled device 140 and the components thereof, and that is transmitted to the controlled device 140. The controlled-device control information also corresponds to the communication environment to be connected (step S13). That is, in the driver 116, a control instruction is converted to a format corresponding to the specifications of the controlled device 140 for the first time. The driver 116 converts the driver control information to the controlled-device control information (device correspondence command) based on the correspondence information list that describes correspondence between the driver control information and the controlled-device control information (device correspondence command) stored in the memory 124 of the driver 116. The driver 116 transmits the controlled-device control information (device correspondence command) converted, to the controlled device 140 through the second communicator 120. If the controlled device 140 is present in plurality or if the controller 144 is present in plurality in one controlled device 140, a transmission target of the controlled-device control information (device correspondence command) is appropriately selected based on the selection information for the controlled device and the controller that is included in the controlled-device control information (device correspondence command).

In the controlled device 140, the communicator 142 receives the controlled-device control information (device correspondence command) from the driver 116 of the gateway device 110. The controller 144 controls the controlled device 140 and the components thereof according to the controlled-device control information (device correspondence command) (step S14). The above-mentioned flow allows the control device 100 to control the controlled device 140. If there is any return value to be returned from the controlled device to the control device, the above process is reversely processed. More specifically, when a return value is to be sent from the controlled device 140 to the gateway device 110, the driver 116 performs reverse conversion so that the return value is converted to data information that the server entity 114 can interpret. The return value converted is transmitted to the server entity 114 and is reversely converted to return value information for transmission, to the control device, that the control device can interpret. The return value information converted is transmitted to the control device 100. The control device 100 receives the return value information and performs a predetermined process thereon.

As explained above, in the manufacturing system, the control request information for controlling the controlled device 140 is in abstract description format, and the control instruction is transmitted between the control device 100 and the gateway device 110 based on the control information in the abstract description format. This allows the gateway device 110 to reliably transmit the control instruction to an arbitrary application that has the control request information in the abstract description format. The application has the control request information in the abstract description format, which allows the gateway device 110 to use any application regardless of specifications of the controlled devices 140. Thus, a greater degree of flexibility is obtained in selection of applications.

Since the gateway device 110 has the driver 116 supporting the specifications of the controlled device 140, specifically the specifications of the controller 144, the gateway device 110 can convert control instruction information in the abstract specification format transmitted from the control device 100, to a control instruction matching the specifications of the corresponding controlled device 140. This allows reliable control of the controlled device 140. If the controlled device is to be replaced, by only mounting a driver supporting a new controlled device in the gateway device 110, the gateway device 110 can control the controlled device without replacement of the application. Therefore, in the manufacturing system, a greater degree of flexibility is obtained in a combination of an application and a controlled device.

In the above explanation, as shown in FIG. 3, the control flow is explained in such a manner that the controlled device 140 or the components thereof are controlled based on the controlled-device control information (device correspondence command) transmitted from the driver 116 to the controller 144. However, the present invention allows any configuration in which the control is performed not through the controller 144. For example, there is a case where the contents of a control request from the control device 100 are a collection of information for particular bits of a resource in the device. In this case, the driver control information is transmitted from the server entity 114 to a specific device driver 116a, and device control information (device correspondence command) is transmitted from the device driver 116a to the controlled device 140. Access can be made from the device driver 116a to a communication line 152 in the controlled device 140 not through the controller 144, as indicated by arrow S of FIG. 3, to collect information for particular bits of the resource in the device, for example, in the CNC.

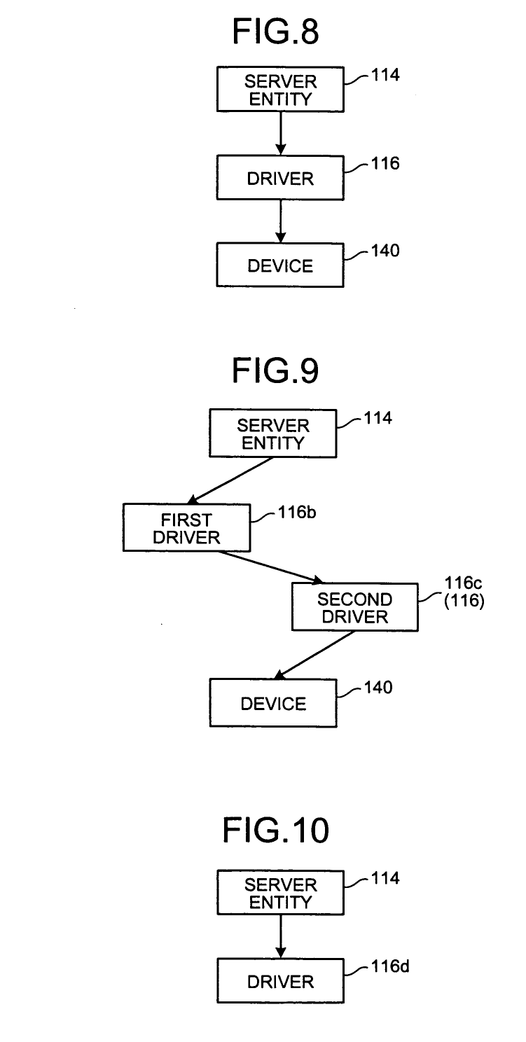

In the above explanation, as shown in FIG. 8, the control flow is explained in such a manner that the driver control information is transmitted from the server entity 114 to the driver 116, and that the controlled-device control information (device correspondence command) is transmitted from the driver 116 to the controlled device 140. However, the present invention allows any configuration other than this. For example, the configuration as follows may also be allowed. That is, as shown in FIG. 9, the driver control information is first transmitted from the server entity 114 to a first driver 116b, where the driver control information is subjected to predetermined code conversion, and the driver control information converted is transmitted to a second driver 116c. The controlled-device control information (device correspondence command) is transmitted from the second driver 116c to the controlled device 140 (device). As shown in FIG. 10, it is also possible to obtain another configuration such that the driver control information is sent from the server entity 114 to a driver 116d and the process for the driver control information is completed therein. In this case, the driver 116d itself executes a predetermined function. The contents of functions to be executed include, for example, exclusive control of a call for the driver 116 and the device driver 116a, interface implementation history, filing of time stamp and history of interface implementation, and conversion of interface exchange data structure (conversion of code and bit byte, etc).

The gateway device 110 can be constructed in the following manner. At first, design information and function information such as installation specifications, a mechanical design package, a control S/W design package, a control panel design package, and controller specifications of the controlled device 140 and devices thereof, i.e., capabilities are described according to a common description model. In other words, they are described in, for example, the IDL that is the abstract interface description language. All the capabilities are extracted from the design specifications and the mechanical design package of the controlled device 140 and the devices thereof for description. Therefore, in the capabilities, all the functions that are executable by the controlled device 140 and the devices thereof are described in the abstract interface description language, which allows the functions of the controlled device 140 and the devices thereof to be obtained through the capabilities.

By describing the capabilities according to the common description model in the above manner, any third person other than the developers of the application can easily carry out deletion of the design data, addition of new design data, or search of design data if necessary. As a result, even if work environment of the development and maintenance of the application is changed due to absence, transfer, or retirement of the developers, any third person can perform these works easily. Therefore, by describing the capabilities according to the common description model, the greater degree of flexibility can be obtained in the development and maintenance of applications.

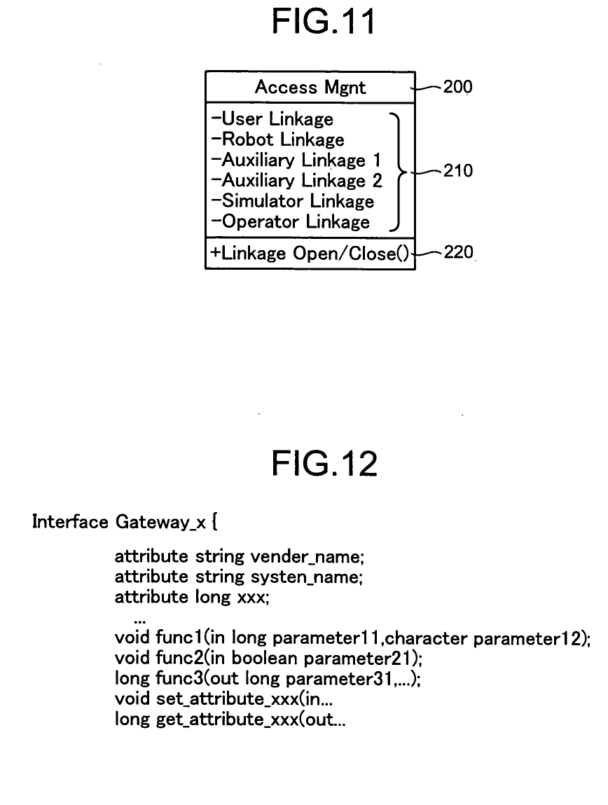

When the capabilities are described in the abstract interface description language, a class is described in an area 200 of a table as shown in FIG. 11, an attribute and a parameter thereof are described in an area 210, and contents of operation are described in an area 220. All the functions of all the controlled devices and components thereof are described in the above manner to prepare a capability file. A device capability file (capabilities of a controlled device) and a device-component capability file (capabilities of the components of the controlled device) are prepared. An example of description in the IDL is shown in FIG. 12. In actual cases, a capability file prepared up to this stage is carried out in manufacturers of the controlled device, and the capability file prepared is provided from the manufacturers.

A separate driver is prepared for a controlled device. This separate driver is also provided from the manufacturer in the actual cases. The drivers are provided in, for example, C-language source code (binary file) format.

Thereafter, the capabilities are mounted on the gateway device. A correspondence information list file that describes correspondence between the control request information and the driver control information is mounted on the server entity 114 of the gateway device 110. The driver 116 corresponding to the controller 144 of the controlled device 140 is mounted thereon, and a correspondence information list file that describes correspondence between the driver control information and the controlled-device control information (device correspondence command) is mounted on the driver 116. The resource-name conversion file 126 is prepared using extensible markup language (XML) from the installation specifications, the mechanical design package, the control S/W design package, the control panel design package, or the controller specifications of the controlled device 140 and components thereof. The resource-name conversion file 126 prepared is mounted on the database 118 of the gateway device 110. The first communicator 112 and the second communicator 120 are mounted to enable configuration of the gateway device 110. If the driver 116 is present in plurality and the device driver 116a is present, then these devices are further mounted. It is noted that the gateway device 110 can be configured with hardware or with software.

In the present invention as explained above, the manufacturers of the controlled devices only provide the capability files and the drivers. Therefore, the manufacturers can manufacture and supply the controlled devices by the original specifications of their companies, without caring about the specifications of applications as higher-order devices. This allows the greater degree of design flexibility in the specifications of the controlled devices.

Manufacturers of the gateway devices or makers using the manufacturing systems are provided with the capability files and the drivers from the manufacturers of the controlled devices. Therefore, the manufacturers can easily manufacture the gateway devices without complicated development, and can also manufacture the gateway devices in a short development and manufacturing time for delivery and at low development and manufacturing costs.

Manufacturers of the applications or makers using the manufacturing systems are provided with the capability files from the manufacturers of the controlled devices. Therefore, the manufacturers can easily manufacture and deliver the applications without complicated development and without caring about the specifications of low-order controlled devices. This allows the manufacturers to prepare the applications in a short development and manufacturing time for delivery and at low development and manufacturing costs.

The makers using the manufacturing systems can control controlled devices of different specifications in various fields without replacement of the applications only by exchanging specific domain information (which is specific to a controlled device such as control request information, capabilities of the controlled device, capabilities of components of the controlled device, and a resource-name conversion file) with corresponding one. Furthermore, for example, even if a controlled device is replaced with another one due to failure or a controlled device is replaced with a new one, the new controlled device can be controlled only by exchanging the specific domain information with corresponding one without replacement of applications. In other words, the gateway device functions as a gateway device capable of supporting various devices only by exchanging the specific domain information with corresponding one.

Therefore, the present invention allows flexibility of a combination of an application and a controlled device, which makes it possible to realize the manufacturing system capable of flexibly supporting the combinations, and realize the gateway device that forms the manufacturing system.

In the embodiment, more specific examples about the control of the controlled device in the manufacturing system configured in the above manner are explained below with reference to the drawings. In this embodiment, the configuration of FIG. 3 is used for the following explanation.

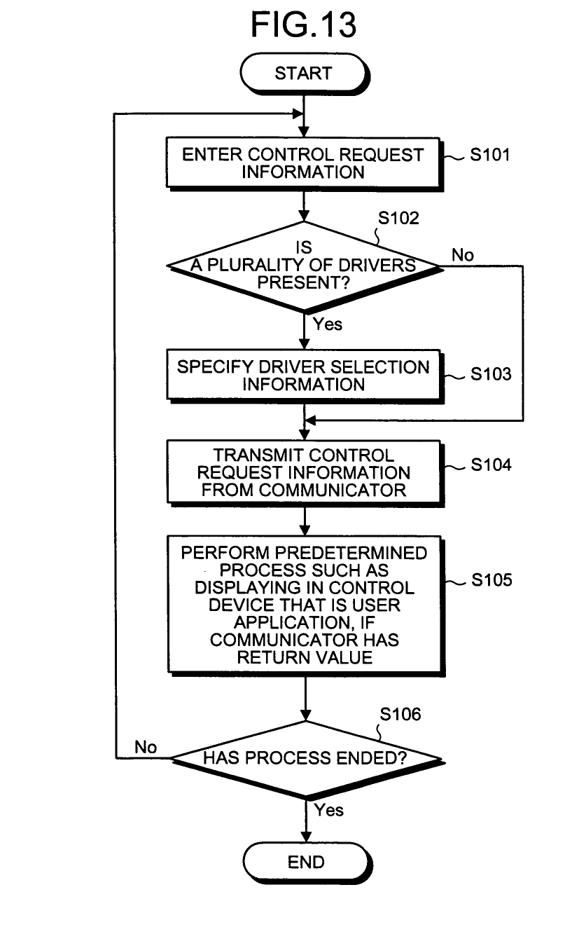

The operation of the control device 100 is explained below with reference to FIG. 13. At first, the user enters manufacture request information (manufacture direction) that is a control request item for the controlled device 140, into the application 102 of the control device 100 (step S101). Upon entry of the manufacture request information, a manufacture direction such that a product of “X” is manufactured by “Y pieces” using a device of “Type A” and attributes for the manufacture direction are entered. The attributes include a machining line type, a machining device type, an operation name, a quantity, a machining program, necessary memory capacity, and so on. The attributes are entered not as a device correspondence command but in the abstract specification format.

The manufacture request information (manufacture direction) can be configured such that when the user enters a work schedule in a scheduler or so, a work list is automatically prepared from the scheduler and the list as the manufacture request information is downloaded to the control device 100. Furthermore, the configuration may be another one such that the user discretely enters a specific instruction. With this configuration, predetermined control request information is selected and specified in the client entity 106 of the application 102 of the control device 100.

If a plurality of drivers is present in the gateway device 110, the control request information includes the driver selection information as appended information used to select a driver in the gateway device 110. Therefore, the client entity 106 of the application 102 also specifies driver control information. In other words, when receiving the manufacture request information, the client entity 106 determines whether a plurality of drivers is present in the gateway device 110 (step S102).

If it is determined that the drivers are present in the gateway device 110 (Yes at step S102), predetermined driver selection information is selected and specified as appended information for the control request information (step S103). It is noted that the driver selection information can be individually selected and specified. If only one driver is present in the gateway device 110 (if there is not a plurality of drivers) (No at step S102), the driver is specified as appended information.

The client entity 106 of the application 102 transmits the control request information to the communicator 108, and further instructs the communicator 108 to transmit the control request information to the gateway device 110. The communicator 108 receives the control request information from the client entity 106 and transmits the control request information received to the gateway device 110 (step S104). If receiving a return value from the gateway device 110, the communicator 108 transmits the return value to the client entity 106. When having received the return value, the client entity 106 performs a predetermined process such that a command corresponding to the return value is displayed on a display (step S105).

It is determined whether the process has ended in the client entity 106 (step S106). If the process has ended, a series of operations is finished. If the process has not ended, the process returns to step S101, where the process is repeated until a series of processes ends.

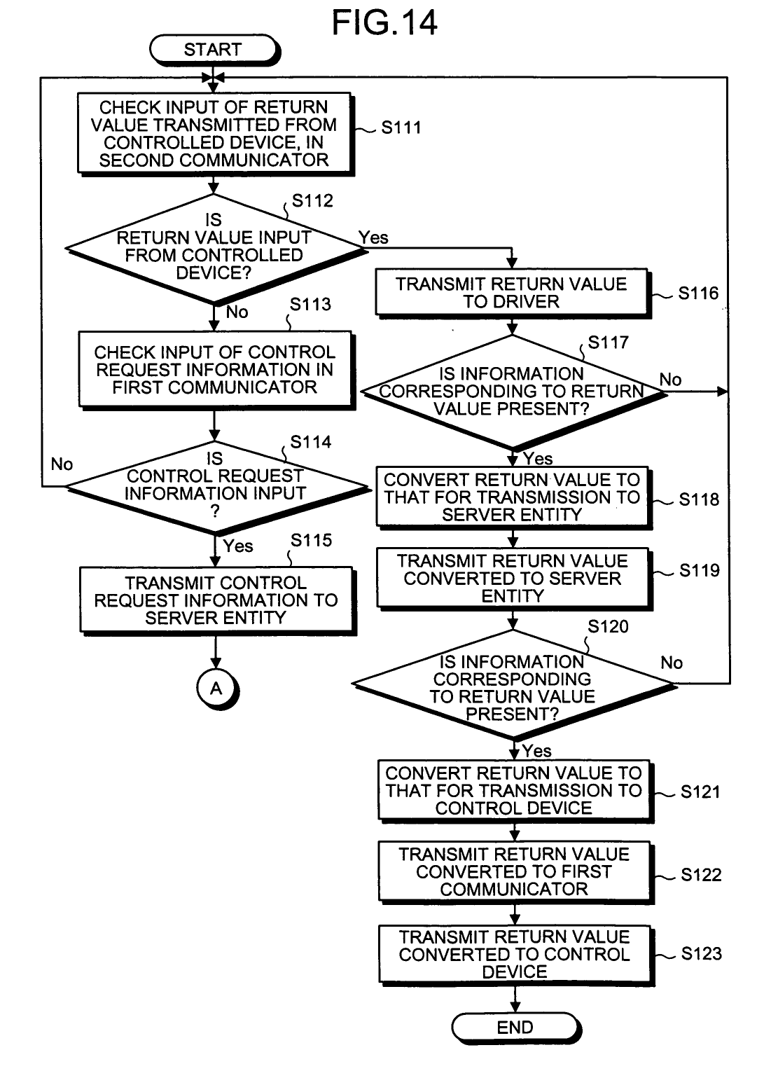

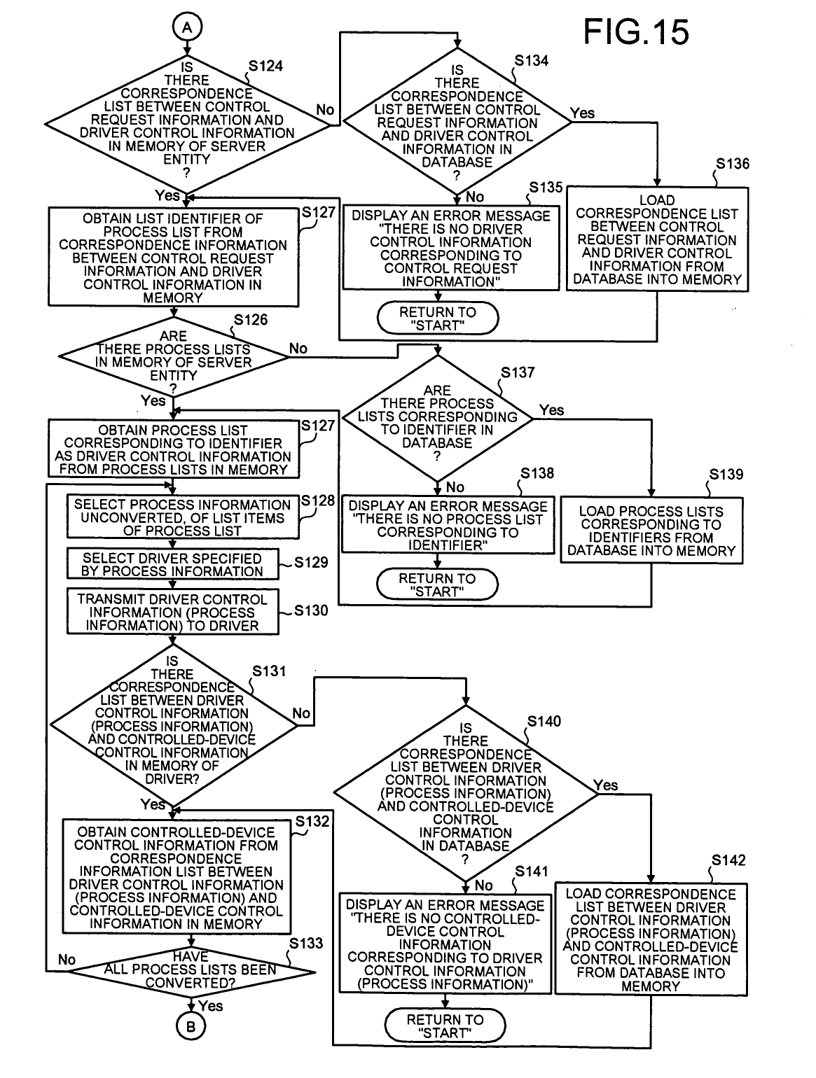

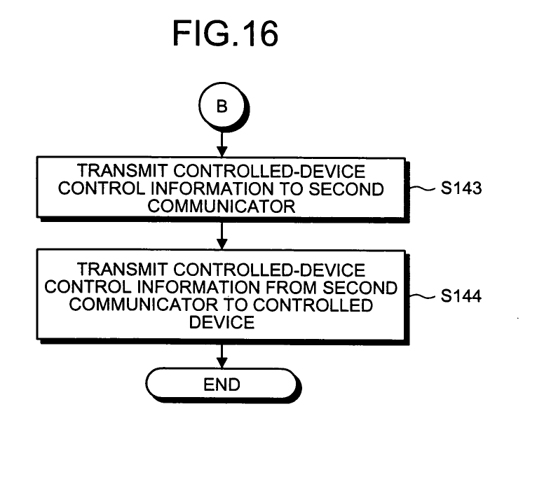

The operation of the gateway device 110 is explained below with reference to FIG. 14 to FIG. 16. In the gateway device 110, the second communicator 120 checks an input of a return value from the controlled device 140 (step S111), and determines whether there is the return value from the controlled device 140 (step S112). If there is the return value from the controlled device 140 (Yes at step S112), the second communicator 120 transmits the return value to the driver 116 (step S116). The driver 116 checks reverse-conversion correspondence information or a reverse-conversion correspondence information list included in the correspondence information list that is stored in the memory 124, and determines whether information for the corresponding return value is present therein (step S117). If the information for the corresponding return value is present (Yes, step S117), the return value is reversely converted to return value information for transmission to the server entity 114, using the reverse-conversion correspondence information or the reverse-conversion correspondence information list included in the correspondence information list (step S118). The return value information converted is transmitted to the server entity 114 (step S119).

If the information for the corresponding return value is not present in the reverse-conversion correspondence information or the reverse-conversion correspondence information list (No at step S112), the process returns to step S111.

The server entity 114 receives the return value information converted, checks reverse-conversion correspondence information or a reverse-conversion correspondence information list included in the correspondence information list stored in the memory 122, and determines whether the corresponding return value information is present therein (step S120). If the corresponding return value information is present (Yes at step S120), the server entity 114 reversely converts the return value information having been reversely converted in the driver 116 to return value information for transmission to the control device 100, using the reverse-conversion correspondence information or the reverse-conversion correspondence information list (step S121). The return value information reversely converted is transmitted to the first communicator 112 (step S122). The first communicator 112 transmits the return value information reversely converted that is received from the server entity 114, to the control device 100 (step S123).

If the information for the corresponding return value is not present in the reverse-conversion correspondence information or the reverse-conversion correspondence information list (No at step S120), the process returns to step S111.

The second communicator 120 determines whether there is the return value from the controlled device 140. If no return value is transmitted from the controlled device 140 (No at step S112), the first communicator 112 checks an input of the control request information (step S113), and determines whether the control request information is input (step S114). If the control request information is not input (No at step S114), the process returns to step S111. If the control request information is input (Yes at step S114), the first communicator 112 transmits the control request information to the server entity 114 (step S115).

The server entity 114 receives the control request information from the first communicator 112 and checks whether the correspondence information list between the control request information and the driver control information is present in the memory 122 of the server entity 114 (step S124). If the correspondence information list is not present in the memory 122 (No at step S124), the server entity 114 checks whether the correspondence information list is present in the database 118 (step S134). If the correspondence information list is not present in the database 118 (No at step S134) as a result of checking, an error message, for example, “there is no driver control information corresponding to the control request information” is displayed (step S135).

On the other hand, as a result of checking whether the correspondence information list is present in the database 118, if it is present in the database 118 (Yes at step S134), the server entity 114 loads the correspondence information list from the database 118 into the memory 122 of the server entity 114 (step S136). This allows conversion of the control request information to corresponding one in the server entity 114.

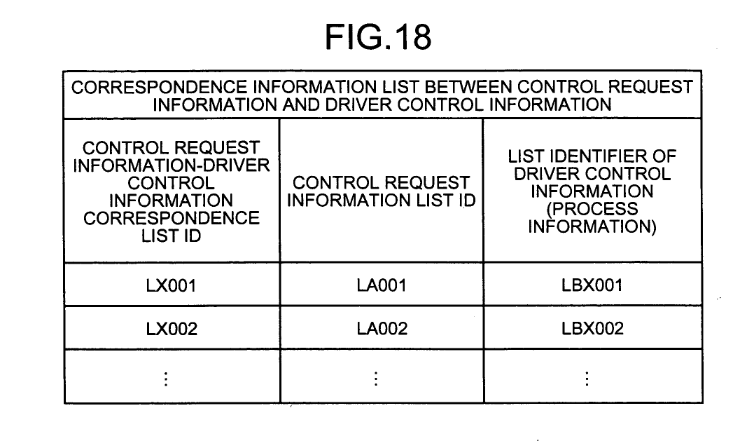

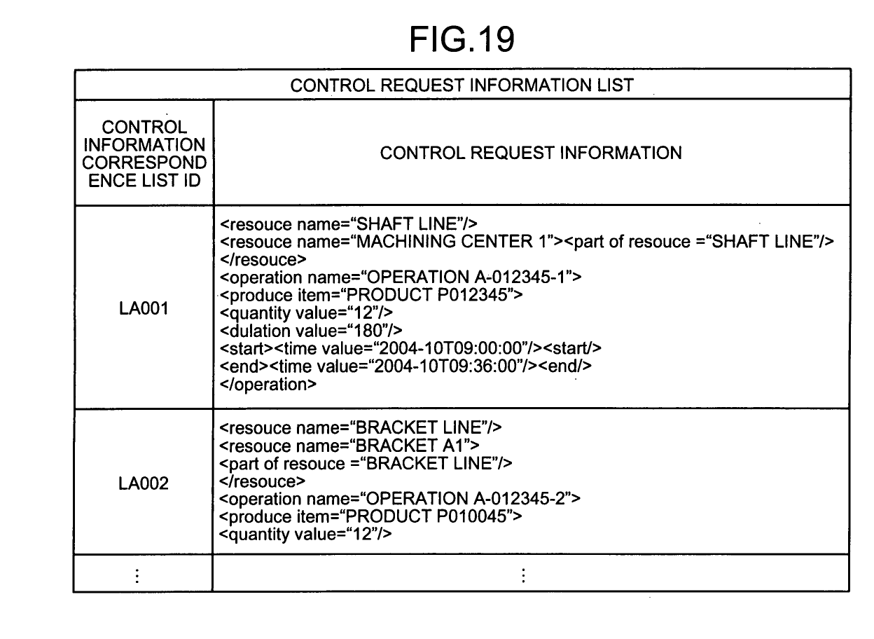

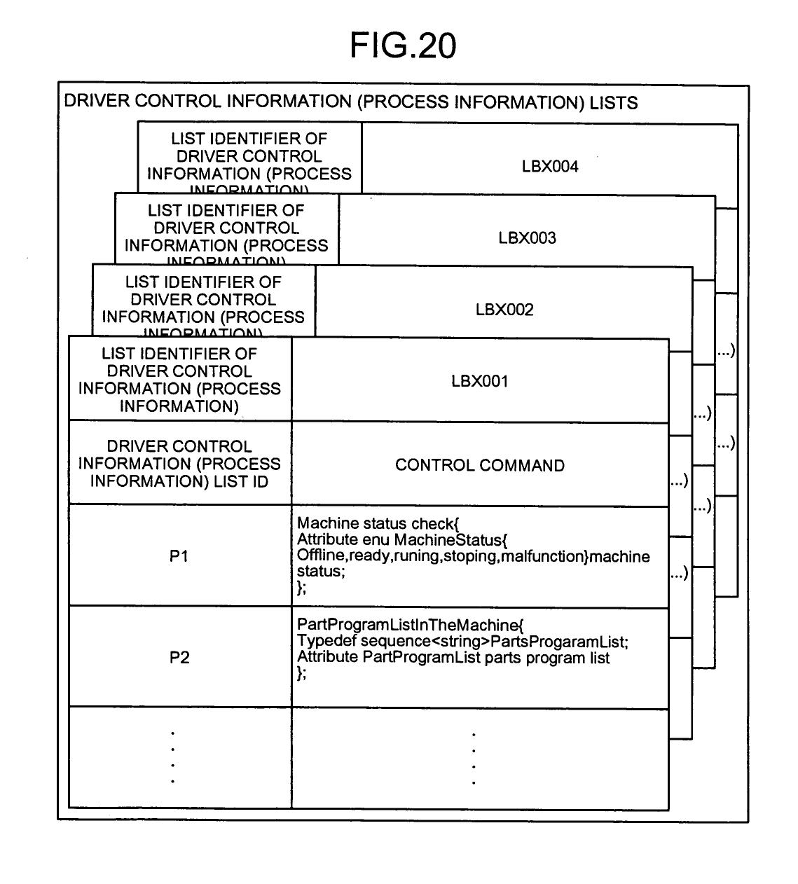

As the correspondence information list between the control request information and the driver control information, a correspondence information list as shown in FIG. 18 can be used. The correspondence information list between the control request information and the driver control information of FIG. 18 includes a control request information list ID, a list identifier of driver control information (process information) corresponding thereto, and a control request information-driver control information correspondence list ID that manages combinations of these lists as sets. Separately from the correspondence information, the memory 122 stores a control request information list as shown in, for example, FIG. 19 and driver control information (process information) lists as shown in, for example, FIG. 20.

The control request information list of FIG. 19 include details of the control request information described in the abstract specification and the control request information list ID corresponding to the details. As shown in FIG. 19, the control request information describes manufacturing directions (manufacturing command) that are described not in an individual specification command corresponding to a device but in the abstract specifications such as “resource name” that indicates a type of a work line and a work device, “operation name” that is the contents of an operation, and “produce item” that is a product name. If the controlled device 140 is controlled based on the control request information, return values for verification of operations for each of the items are returned from the controlled device 140, and the control is verified.

The driver control information (process information) lists of FIG. 20 are a set of the driver control information (process information) lists prepared based on the capabilities of the controlled device 140 and the components thereof. Individual driver control information (process information) list is a list in which control commands that are an operation sequence are prepared for each identifier of driver control information (process information) lists based on the capabilities of the controlled device 140 and the components thereof. The driver control information (process information) list IDs and the contents of corresponding commands are described in the abstract specification in the lists.

By using these lists, it is possible to accurately check that the capabilities of the controlled device 140 and the components thereof corresponding to the control request information are present. That is, it is possible to accurately check whether an operation corresponding to the control request information is allowed to be performed or not in the controlled device 140 and the components thereof. For example, if a list identifier (e.g., LBX001) of driver control information (process information) corresponding to a control request information list ID (e.g., LA001) is present, then the control request information can be converted to the driver control information (process information).

If the correspondence information list is present in the memory 122 of the server entity 114 (Yes at step S124) or if the process at step S136 ends, the server entity 114 obtains a list identifier of driver control information (process information) from the correspondence information list between the control request information and the driver control information of FIG. 18 (step S125).

The server entity 114 checks whether the driver control information (process information) lists of FIG. 20 are present in the memory 122 of the server entity 114 (step S126). If they are not present in the memory 122 (No at step S126), the server entity 114 checks whether the driver control information (process information) lists are present in the database 118 (step S137). As a result, if they are not present in the database 118 (No at step S137), an error message, for example, “there is no process list corresponding to the identifier” is displayed (step S138).

On the other hand, as a result of checking whether the driver control information (process information) lists are present in the database 118, if they are present in the database 118 (Yes at step S137), the server entity 114 loads the lists from the database 118 into the memory 122 of the server entity 114 (step S139). This allows conversion from a list identifier of driver control information (process information) to a driver control information (process information) list ID in the server entity 114.

If the driver control information (process information) lists are present in the memory 122 of the server entity 114 (Yes at step S126) or if the process at step S139 ends, the server entity 114 obtains a driver control information (process information) list ID from the driver control information (process information) lists of FIG. 20 (step S127). Each result corresponding to the correspondence information list can be obtained by a compiler for each input of control request information instead of using the correspondence information list.

Next, the server entity 114 selects driver control information (process information) that has not yet been converted to controlled-device control information, i.e., driver control information (process information) that has not been transmitted to the driver 116, out of the driver control information (process information) list (step S128). Then, the server entity 114 selects the driver 116 specified by the driver control information (process information) (step S129). The server entity 114 transmits the driver control information (process information) selected to the driver 116 (step S130).

The server entity 114 performs such a series of operations. If receiving the return value information reversely converted from the driver 116, the server entity 114 checks the reverse-conversion correspondence information or the reverse-conversion correspondence information list included in the correspondence information list stored in the memory 122, and determines whether corresponding return value information is present therein. If the corresponding return value information is present therein, the server entity 114 reversely converts the return value information having been reversely converted in the driver 116 to return value information for transmission to the control device 100, using the reverse-conversion correspondence information or the reverse-conversion correspondence information list included in the correspondence information list, and transmits the return value information reversely converted to the first communicator 112.

The driver 116 that receives the driver control information (process information) checks whether the correspondence information list between the driver control information (process information) and the controlled-device control information is present in the memory 124 of the driver 116 (step S131). If the correspondence information list is not present in the memory 124 (No at step S131), the driver 116 checks whether the correspondence information list is present in the database 118 (step S140). If the correspondence information list is not present in the database 118 (No at step S134) as a result of checking, an error message, for example, “there is no controlled-device control information corresponding to the driver control information (process information)” is displayed (step S141).

On the other hand, as a result of checking whether the correspondence information list is present in the database 118, if it is present in the database 118 (Yes at step S140), the driver 116 loads the correspondence information list from the database 118 into the memory 124 of the driver 116 (step S142). This allows conversion of the driver control information (process information) to corresponding one in the driver 116.

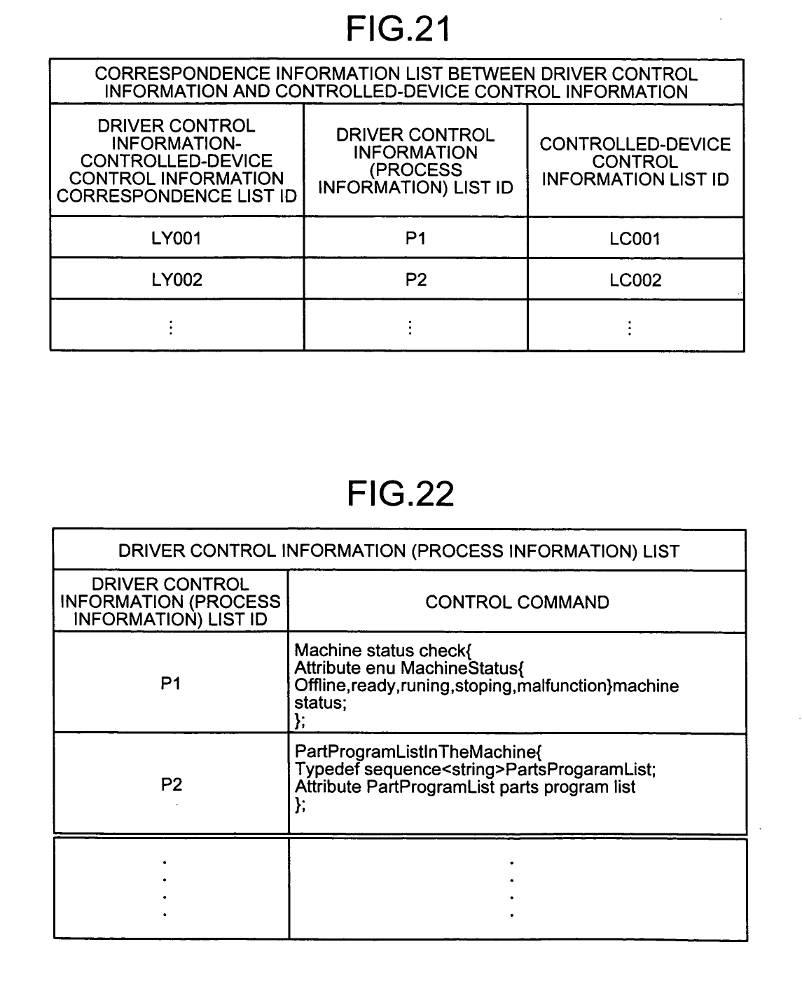

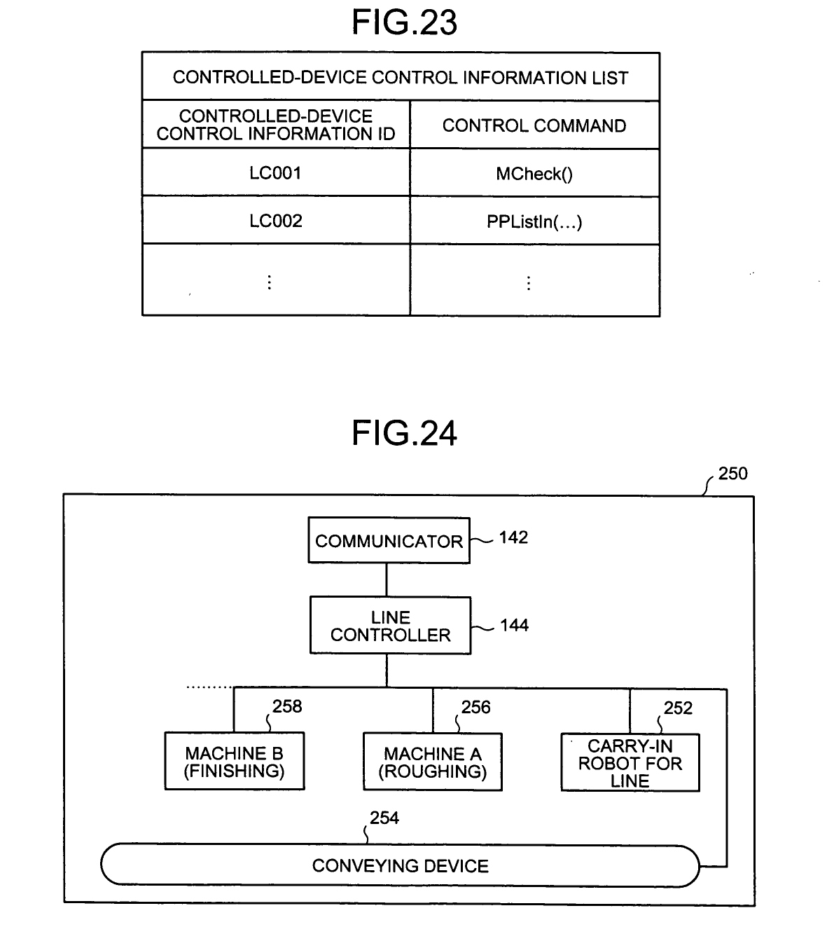

As the correspondence information list between the driver control information (process information) and the controlled-device control information, a correspondence information list as shown in FIG. 21 can be used. The correspondence information list between the driver control information (process information) and the controlled-device control information of FIG. 21 includes a driver control information (process information) list ID, a controlled-device control information list ID corresponding thereto, and a driver control information-controlled-device control information correspondence list ID that manages combinations of these lists as sets. Separately from the correspondence information, the memory 124 stores a driver control information (process information) list as shown in, for example, FIG. 22 and a controlled-device control information list as shown in, for example, FIG. 23.

The driver control information (process information) list of FIG. 22 is obtained by excluding the list identifier of driver control information (process information) from each of the driver control information (process information) lists of FIG. 20. More specifically, the driver control information (process information) list is a list in which control commands that indicate an operation sequence are prepared for each list identifier based on the capabilities of the controlled-device control information and the components thereof. The driver control information (process information) list IDs (e.g., P1, P2) and the contents of corresponding commands are described in the abstract specification in the lists.

The controlled-device control information list of FIG. 23 is described as a control command for individual specification that is a device correspondence command including a controlled-device control information list ID and a corresponding control command.

By using these lists, it is possible to accurately check that the capabilities of the controlled device 140 and the components thereof corresponding to the driver control information are present. That is, it is possible to accurately check whether an operation corresponding to the driver control information (process information) is allowed to be performed or not in the controlled device 140 and the components thereof. If controlled-device control information list ID (e.g., LC001) corresponding to a driver control information (process information) list ID (e.g., P1) is present, then the driver control information (process information) can be converted to the controlled-device control information in individual specification corresponding to a device. In other words, the control request information is converted to information in individual specification corresponding to the device in the driver 116 for the first time.

If the correspondence information list is present in the memory 124 of the driver 116 (Yes at step S131) or if the process at step S142 ends, the driver 116 obtains a controlled-device control information that is a control command corresponding to the device, from the correspondence information list between the driver control information (process information) and controlled-device control information of FIG. 21 (step S132). Each result corresponding to the correspondence information list can be obtained by a compiler for each input of driver control information (process information) instead of using the correspondence information list.

Next, the driver 116 determines whether all pieces of the driver control information (process information) have been converted to controlled-device control information (step S133). If some driver control information (process information) remains unconverted (No at step S133), the process returns to step S128. If all pieces of the driver control information (process information) have been converted to controlled-device control information (Yes at step S133), the driver 116 transmits the controlled-device control information to the second communicator 120 (step S143). The second communicator 120 transmits the controlled-device control information received to the controlled device 140 (step S144).

The driver 116 performs such a series of operations. If receiving the return value information from the controlled device 140, the driver 116 checks the reverse-conversion correspondence information or the reverse-conversion correspondence information list included in the correspondence information list stored in the memory 124, and determines whether corresponding return value information is present therein. If the corresponding return value information is present therein, the driver 116 reversely converts the return value to return value information for transmission to the server entity 114, using the reverse-conversion correspondence information or the reverse-conversion correspondence information list included in the correspondence information list, and transmits the return value information reversely converted to the server entity 114.

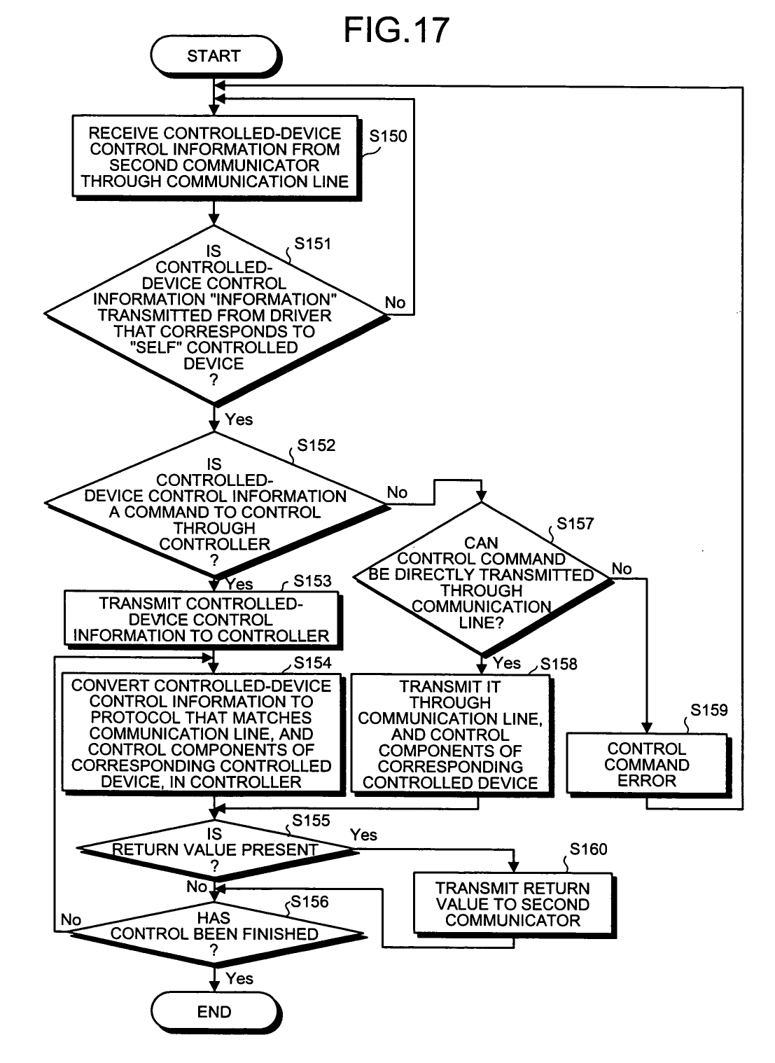

The operation of the controlled device 140 is explained below with reference to FIG. 17. In the controlled device 140, the communicator 142 receives the controlled-device control information converted to the control command corresponding to the device, from the second communicator 120 through the communication line 156 (step S150). When receiving the controlled-device control information, the communicator 142 checks whether the controlled-device control information is transmitted from a driver that corresponds to a “self” controlled device 140 (step S151). If the controlled-device control information received is not transmitted from the driver that corresponds to the self controlled device 140 (No at step S151), the process returns to step S150.

If the controlled-device control information received is transmitted from a driver corresponding to the self controlled device 140 (Yes at step S151), the communicator 142 checks whether the controlled-device control information is a control command that controls the components through the controller 144 (step S152). If the controlled-device control information received is not the control command that controls them through the controller 144 (No at step S152), the communicator 142 checks whether the controlled-device control information is a control command that can be transmitted through the communication line 152 (step S157).

If the controlled-device control information is the control command that cannot be transmitted through the communication line 152 (No at step S157), the communicator 142 determines that it is a control command error (step S159), and the process returns to step S150. On the other hand, if the controlled-device control information is the control command that can be transmitted through the communication line 152 (Yes at step S157), the communicator 142 transmits the controlled-device control information over the communication line 152 (step S158) to control the components (146, etc) of the corresponding controlled device 140.

If the controlled-device control information received is a control command that controls the components through the controller 144 (Yes at step S152), the communicator 142 transmits the controlled-device control information to the controller 144 (step S153). The controller 144 converts the controlled-device control information to a protocol that matches the communication line 152, and controls the components (146, etc) of the corresponding controlled device 140 (step S154).

The controller 144 checks whether a return value is returned from the components of the controlled device 140 (step S155). If there is any return value (Yes at step S155), the controller 144 transmits the return value to the second communicator 120 of the gateway device 110 through the communicator 142 (step S160). On the other hand, if there is no return value (No at step S155), the controller 144 checks whether the control for the components of the controlled device 140 has been finished (step S156). If the control for the components of the controlled device 140 has not been finished (No at step S156), the process returns to step S154. If the control for the components (146, etc) of the controlled device 140 has been finished (Yes at step S156), a series of control for the controlled device 140 is finished.

An example of the configuration of the controlled device is the one based on an image of, for example, a material machining line. As shown in FIG. 24, the configuration may also include the communicator 142, the controller 144, a carry-in robot 252 for line that carries materials to be machined that form a controlled device 250 in a manufacturing line, a conveying device 254 that conveys the materials along the manufacturing line, a machine A 256 that performs roughing on a material to be machined, and a machine B 258 that performs finishing on the material. The controller 144, the carry-in robot 252 for line, the conveying device 254, the machine A 256, and the machine B 258 are connected to one another through a network 260 of the controlled device 140.

According to the present invention, the higher degree of a combination of the application that controls a controlled device and the controlled device can be obtained, which makes it possible to achieve the manufacturing system capable of flexibly supporting a variety of combinations of the applications and the controlled devices.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A manufacturing system comprising a gateway device that connects a control device and a controlled device, wherein the gateway device includes
a receiving unit that receives a control request written in an abstract interface description language from the control device;
a converter that converts the control request to driver control information;
a driver that converts the driver control information to controlled-device control information and controls the controlled device based on the controlled-device control information; and
a transmitting unit that transmits the controlled-device control information to the controlled device.

2. The manufacturing system according to claim 1, wherein the gateway device further includes
a storage unit that stores correspondence information between the control request and the driver control information, and
the converter converts the control request to the driver control information based on the correspondence information.

3. The manufacturing system according to claim 1, wherein the gateway device further includes
a storage unit that stores correspondence information between the driver control information and the controlled-device control information, and
the driver converts the driver control information to the controlled-device control information based on the correspondence information.

4. The manufacturing system according to claim 1, wherein the gateway device includes a plurality of the drivers.

5. A gateway device that connects a control device and a controlled device, comprising:
a receiving unit that receives a control request written in an abstract interface description language from the control device;
a converter that converts the control request to driver control information;
a driver that converts the driver control information to controlled-device control information and controls the controlled device based on the controlled-device control information; and
a transmitting unit that transmits the controlled-device control information to the controlled device.

6. The gateway device according to claim 5, further comprising:
a storage unit that stores correspondence information between the control request and the driver control information, wherein
the converter converts the control request to the driver control information based on the correspondence information.

7. The gateway device according to claim 5, further comprising:
a storage unit that stores correspondence information between the driver control information and the controlled-device control information, wherein
the driver converts the driver control information to the controlled-device control information based on the correspondence information.

8. The gateway device according to claim 5, wherein the gateway device includes a plurality of the drivers.

9. A computer-readable recording medium that stores a computer program that causes a computer, which functions as a gateway device between a control device and a controlled device, to execute:
receiving a control request written in an abstract interface description language from the control device;
converting the control request to driver control information;
converting the driver control information to controlled-device control information for controlling the controlled device; and
transmitting the controlled-device control information to the controlled device.
